(19) United States
(12) Patent Application Publication
(10) Pub. No.: US 2024/0425109 A1
(43) Pub. Date: Dec. 26, 2024

(54) STEERING COLUMN ASSEMBLY FOR A VEHICLE

(71) Applicants: ZF AUTOMOTIVE GERMANY GMBH, Alfdorf (DE); ZF Automotive UK Limited, Solihull (GB)

(72) Inventors: Stephane CASSAR, CALUIRE-et-CUIRE (FR); Tim BUTTERY, Halesowen (GB); Russell WILSON-JONES, Stratford Upon Avon (GB)

(21) Appl. No.: 18/753,211

(22) Filed: Jun. 25, 2024

(30) Foreign Application Priority Data
Jun. 26, 2023 (GB) 2309600.1

(51) Int. Cl. B62D 6/00; B62D 1/16; B62D 5/00

(52) U.S. Cl. CPC B62D 6/008; B62D 1/16; B62D 5/006

(57) ABSTRACT

A steering column assembly for a vehicle includes an elongate steering column mounted for rotation about its longitudinal axis and configured for attachment of a steering wheel at one end. A gear is connected to the steering column at a location spaced from the steering wheel attachment location and configured to rotate with the steering column. A motor has a rotatable output shaft. A first worm screw is directly connected to and rotatable with the output shaft of the motor and engaged with the gear. A damper includes a rotatable shaft. A second worm screw is directly connected to and rotatable with the shaft of the damper and engaged with the gear. A control means is configured to operate the motor.

### RELATED APPLICATIONS

The present application claims priority from GB Patent Application Serial No. 2309600.1, filed 26 Jun. 2023, the entirety of which is hereby incorporated herein by reference.

### TECHNICAL FIELD

This invention relates to steering column assemblies for vehicles and in particular to such assemblies for use with a steer-by-wire handwheel actuator.

### BACKGROUND

The invention also relates to vehicles comprising a steer-by-wire handwheel actuator in accordance with the invention.

In steer-by-wire arrangements, a handwheel (steering wheel) is connected to one end of a rotatably mounted shaft whose angular displacement is measured to generate a signal which is used to control the orientation of the steered wheels of the vehicle. The arrangement is commonly also provided with an electric motor connected to the shaft to provide a controlled amount of torque in the opposite direction to the torque applied by the driver, in order to provide a sensation of road feel to the driver.

In such arrangements, typically an electric motor under the control of an ECU (electronic control unit) drives a worm screw engaged with a worm gear which rotates with the shaft to which the steering wheel is connected. It is desirable to take steps to ensure that the worm screw is always engaged with the worm gear in order to reduce gear rattle which can occur when the torque and direction of the motor are reversed.

### SUMMARY

In accordance with a first aspect of the present invention, a steering column assembly for a vehicle, comprises:
an elongate steering column mounted for rotation about its longitudinal axis and configured for attachment of a steering wheel at one end;
a gear connected to the steering column at a location spaced from the steering wheel attachment location and configured to rotate with the steering column;
a motor comprising a rotatable output shaft;
a first worm screw directly connected to and rotatable with the output shaft of the motor and engaged with the gear;
a damper comprising a rotatable shaft;
a second worm screw directly connected to and rotatable with the shaft of the damper and engaged with the gear; and control means configured to operate the motor.

The motor is operated to generate a feedback torque to the steering column and steering wheel to provide a sensation of road feel to the driver and the damper augments the motor feedback torque. In addition, in the event of a motor fault, the damper provides a passive feedback torque to the driver. Coupling the damper via a second worm screw engaged with the gear connected to the steering column provides a compact package which is easier to fit into vehicles.

The damper preferably comprises a fluid chamber configured to receive a damping fluid and a body located within the fluid chamber, the body being configured to move with the rotatable shaft of the damper.

The use of such a viscous damper produces a driver feedback torque that increases with steering speed.

The body located within the fluid chamber may comprise a plurality of projections and/or recesses.

The body located within the fluid chamber may be spaced from the wall of the fluid chamber.

The body located within the fluid chamber may comprise a portion of increased width.

The body located within the fluid chamber may form part of the rotatable shaft of the damper or may be attached to the rotatable shaft of the damper.

The rotatable shaft of the damper may additionally be displaceable longitudinally in the direction of its rotational axis.

Providing axial movement and damping of the rotatable shaft of the damper reduces the acoustic noise from backlash between the second worm screw and the gear attached to the steering column, particularly when the direction of rotation of the steering column is reversed.

The rotatable shaft of the damper may be mounted to allow it to pivot or articulate.

This accommodates any lateral movement of the damper shaft as a result of its longitudinal displacement.

Preferably, the steering column assembly comprises bearing means configured to allow pivoting or articulation of the rotatable damper shaft.

The steering column assembly may further comprise biasing means configured to urge the second worm screw towards contact with the gear connected to the steering column.

This reduces the backlash between the second worm screw and the gear attached to the steering column and helps to reduce acoustic rattle noise that can occur, particularly during torque reversals.

Preferably, the steering column assembly comprises bearing means for rotatably mounting the rotatable shaft of the damper, with which the biasing means is engaged.

The biasing means may be engaged with an outer race of the bearing means.

Preferably, the biasing means comprises a spring, for example a leaf spring.

The steering column assembly may further comprise a spring acting on the rotatable output shaft of the motor configured to apply a torque to the motor shaft and/or comprising a spring acting on the rotatable shaft of the damper configured to apply a torque to the damper shaft.

The return spring can be arranged to provide a return torque over the full angular range of the steering column. The net torque provided by the spring may act in a direction to return the steering column to the straight ahead position. In addition, the torque provided by the spring preferably increases as the steering column is rotated further away from the straight ahead position.

The spring acting on the rotatable output shaft of the motor and/or the spring acting on the rotatable shaft of the damper preferably comprises a spiral spring.

The steering column assembly may further comprise motor position sensor means for sensing the rotational position of the motor output shaft, the sensor means comprising a target member rotatable with the motor shaft and a sensor for detecting the target member.

This assists in the calculation of an appropriate feedback torque to be generated by the motor.

The steering column assembly may further comprise position sensor means for sensing the rotational position of the damper shaft, the sensor means comprising a target member rotatable with the damper shaft and a sensor for detecting the target member.

Measurement of the angular displacement and/or velocity of the damper shaft improves the prediction of the amount of torque generated by the damper, and consequently the amount of torque to be generated by the motor.

The steering column assembly may comprise a member configured to rotate with the rotatable damper shaft and with respect to which the damper shaft is displaceable along its rotational axis, and on which the target member is mounted.

Such an arrangement accommodates movement of the damper shaft in an axial direction and ensures that there is a constant spacing between the target member and the sensor means.

For example, the steering column assembly may comprise a cup-shaped member mounted at one end of the rotatable damper shaft and on which the motor position sensor means is mounted.

The first worm screw may form part of the motor output shaft and/or the second worm screw may form part of the rotatable damper shaft.

The first and second worm screws may be engaged at diametrically opposed locations with the gear connected to the steering column.

The steering column assembly preferably comprises a housing within which the first and second worm screws and the gear connecting to the steering column are located.

The present invention also includes vehicle comprising a steering column in accordance with the present invention.

### BRIEF DESCRIPTION OF THE DRAWINGS

By way of example only, specific embodiments of the present invention will now be described with reference to the accompanying drawings, in which:

FIG. 1 is a schematic illustration of a known steer-by-wire steering system;

FIG. 2 is a perspective view, partially cut away, of a first embodiment of steering column assembly in accordance with the present invention;

FIG. 3 is a vertical cross-section through the steering column assembly of FIG. 2, looking in the direction of arrows III-III of FIG. 2, with the portion A shown to an enlarged scale;

FIG. 4 is a side view of the steering column assembly of FIG. 2;

FIG. 5 is a schematic illustration of the torque control of the steering column assembly of FIG. 2;

FIG. 6 is a perspective view, partially cut away, of a second embodiment of steering column assembly in accordance with the present invention;

FIG. 7 is a vertical cross-section through the steering column assembly of FIG. 6, looking in the direction of arrows VII-VII of FIG. 6, with the portion B shown to an enlarged scale;

FIG. 8 is a vertical cross-section through a portion of a third embodiment of steering column assembly in accordance with the present invention, which is a modification of the steering column assembly of FIG. 6;

FIG. 9 is a perspective view, partially cut away, of a fourth embodiment of steering column assembly in accordance with the present invention with the portion C shown to an enlarged scale;

FIG. 10 is a vertical cross-section through the steering column assembly of FIG. 9, looking in the direction of arrows X-X of FIG. 9; and

FIG. 11 is a transverse cross-section through fifth embodiment of steering column assembly in accordance with the present invention, which is a modification which can be used with any of the previous embodiments.

### DESCRIPTION

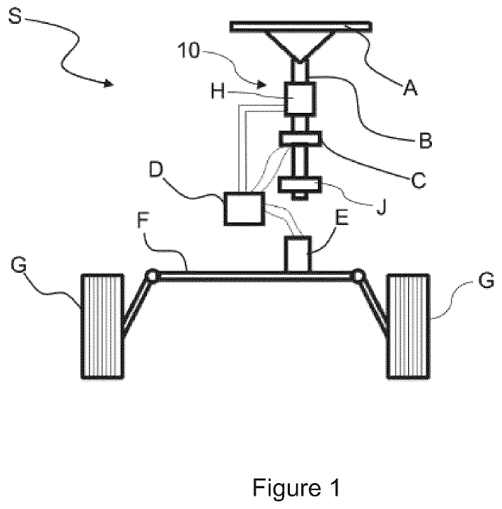

FIG. 1 illustrates a known steer-by-wire system S for a vehicle incorporating a steering assembly 10 in accordance with the present invention. The steer-by-wire system S includes a handwheel actuator, in the form of a steering wheel A, to allow a driver of the vehicle to provide an input steering command. The steering wheel A is connected to an end of an elongate steering shaft B.

A steering input applied through the steering wheel A is measured by a steering sensor forming part of the steering column assembly, shown schematically at C in FIG. 1. A signal representative of the steering input (i.e. the rotation of the steering wheel A and steering shaft B) is transmitted from the sensor C to an electronic control unit (ECU) D which, in turn, controls a steering axle actuator E. The steering axle actuator E applies the steering input to the steering axle F, and therefore steers the steered wheels G as a function of the rotational position of the steering wheel A.

The electronic control unit D is also configured to supply a current to a torque feedback motor H connected to the shaft B and which applies a torque in the opposite direction to the torque applied at the steering wheel A in order to provide a sensation of “road feel” to the driver.

A damper J, illustrated schematically in FIG. 1, is connected to the steering shaft B and introduces a feedback torque to the steering wheel A when a steering input is applied. Whilst FIG. 1 illustrates the damper J mounted part way along the steering shaft B, i.e. between the ends of the steering shaft B such that the steering shaft B passes through the damper J, this need not be the case.

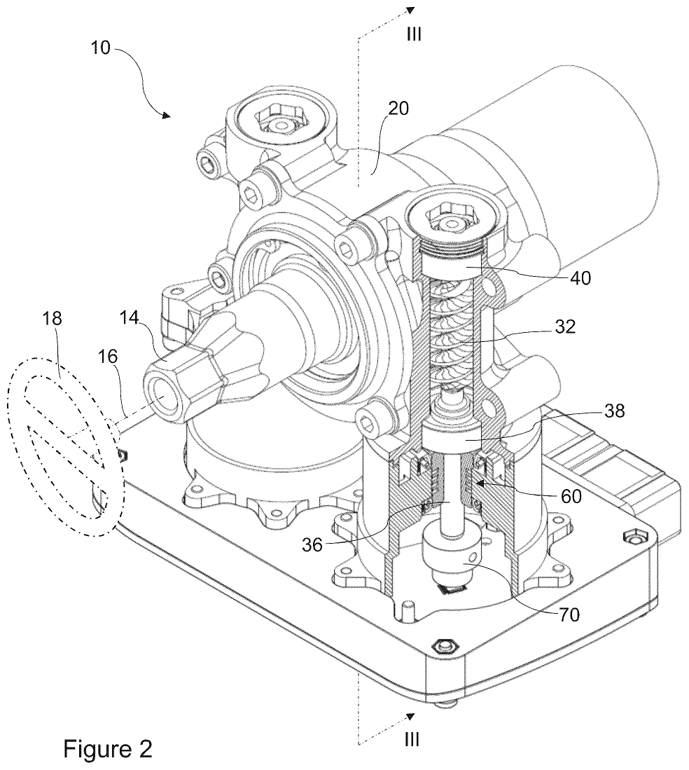

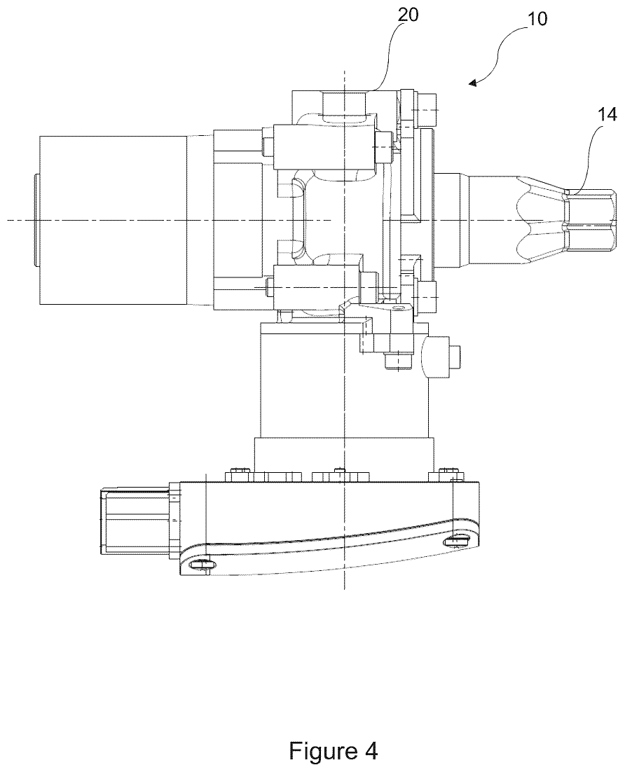

A first embodiment of steer-by-wire column assembly 10 in accordance with the present invention is illustrated in FIGS. 2 to 4. The assembly 10 comprises a straight elongate steer-by-wire steering column 14 (only the lower end of which is illustrated) which is rotatably mounted about its longitudinal axis 16. A steering wheel 18 illustrated schematically in FIG. 1 is secured to the upper end of the steering column 14, by means of which the steering column 14 can be rotated by a driver. In the drawings, the steering column 14 is shown as a single shaft, but in practice it is likely to be formed from a number of components. For example, the steering column may be formed from several telescopic parts and may have a torque sensor (e.g. a torsion bar assembly) between the steering wheel 18 and the opposite end of the steering column 14.

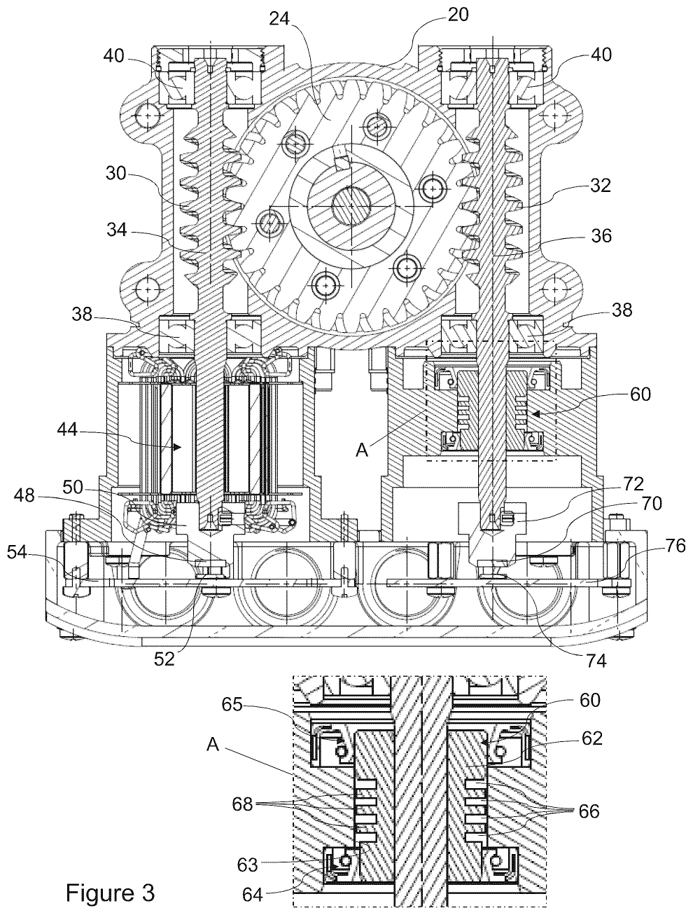

The opposite, lower end of the steering column 14 is received in a housing 20, in which it is rotatably mounted. As best seen in FIG. 3, a spur gear (pinion gear) 24 is fixedly mounted on the lower end of the steering column 14 within the housing 20, and is thereby constrained to rotate with the steering column 14 and steering wheel 18.

Two identical worm screws 30, 32 are rotatably mounted within the housing 20 and are meshed with the spur gear (pinion gear) 24 at diametrically opposed positions on opposite sides of the gear. Each of the worm screws 30, 32 is formed on the surface of a respective shaft 34, 36, the two shafts being oriented parallel to each other and perpendicularly with respect to the rotational axis 16 of the steering column 14. The shafts 34, 36 are rotatably mounted within the housing by means of lower and upper bearings 38, 40 located in use just beyond the lower and upper ends of the worm screws 30, 32.

As best seen in FIG. 3, the first shaft 30 forms the output shaft of an electric motor 44 and is driven directly by the motor. A motion position sensor (MPS) target magnet 48 is fixedly secured to the lower end of a mounting cup 50 secured to the lower end of the shaft 34 below the motor 44 and thereby rotates with the shaft 34. The rotation of the MPS target magnet 40 is detected by a MPS sensor 52 mounted on the upper surface of an MPS sensor circuit board 54 mounted within the housing 20. An electronic control unit (ECU) (not shown in the drawings) is also mounted on the circuit board 54. The MPS target magnet 48 and the MPS sensor 52 are known, and different types of magnets and sensors may be used depending on the circumstances.

With further reference to FIG. 3, a viscous damper indicated generally at 60 is mounted on the other shaft 32 at a location below the lower bearing 38. The viscous damper comprises a generally cylindrical block 62 rotatably mounted within a complementarily-shaped cylindrical recess 63 within the housing 20. The recess 63 contains a damping fluid (e.g. silicone fluid) which is retained by annular lower and upper annular seals 64, 65 in contact with the lower and upper portions respectively of the cylindrical block 62. The central portion of the cylindrical block 62 is provided with four identical, equally spaced annular grooves 66 which define three identical annular fins 68 whose peripheries lie adjacent to, but slightly spaced from, the wall of the recess 63.

The torque applied by the viscous damper is a function of the spacing between the periphery of the cylindrical block 62 and the wall of the recess 63, the number and dimensions of the grooves 66 and annular fins 68 and the viscosity of the damping fluid, as will be discussed further below.

A motion position sensor (MPS) target magnet 70 is fixedly secured to the lower end of a mounting cup 72 secured to the lower end of the damper shaft 36 below the viscous damper 60 and thereby rotates with the shaft 36. The rotation of the MPS target magnet 70 is detected by a MPS sensor 74 mounted on the upper surface of an MPS sensor circuit board 76. The MPS target magnet 70 and the MPS sensor 74 are known, and different types of magnets and sensors may be used depending on the circumstances.

The motor 44 provides a feedback torque to the steering column 16 (and thereby to the steering wheel 18) as a function of the driver demand. The viscous damper 60 also resists rotation of the steering wheel and applies a feedback torque to the driver which is a function of the speed of rotation of the steering wheel. The viscous damper 60 also helps to retain the worm 30 connected to the output of the motor 44 in contact with the spur gear 24 and helps to reduce gear rattle which can occur when the torque and direction of the motor are reversed. In addition, the viscous damper 60 also ensures that some degree of feedback torque is always generated, even if the motor 44 is inoperative.

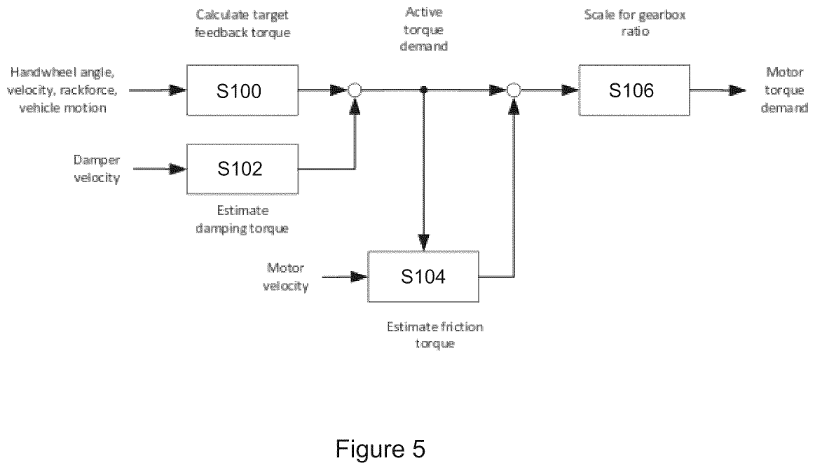

The embodiment described above may be controlled in accordance with the method illustrated schematically in FIG. 5. In the following description, “step” is abbreviated to “S”.

At S100 a desired driver feedback torque is calculated, in a known manner, using information from, the angular displacement and angular velocity of the handwheel actuator (e.g. the steering wheel 18). There may be other inputs involved in the calculation, such as the estimated front axle actuator rack force, inputs from vehicle motion sensors (e.g. yaw rate, lateral acceleration and vehicle speed) and the like. At S102, the damper torque is estimated according to the damper angular velocity calculated from the position of the damper as determined by the MPS target magnet 70 and the MPS sensor 74, for example by determining the change in angular position over an interval of time. Alternatively, the angular velocity of the damper can be estimated at S102 by measuring a different system component, such as the movement and/or position of the motor 44 and/or or the steering column 14 and inferring the damper angular velocity.

The damper torque estimated at S102 is then subtracted from the overall torque demand calculated at S100 and the remainder is the torque required from the motor 44. Optionally, at S104 a friction compensation torque component may be estimated by known methods, from the torque required from the motor 44 and a signal representative of the velocity of the motor 44. The estimated friction compensation torque component is added to the previously calculated torque required from the motor 44 and at S106 the active demand is scaled by the gearbox ratio to determine a torque demand for the motor 44.

Optionally, a sensor may be installed in the input shaft 14/16 to measure the net torque felt by a driver. In that case, a closed-loop can be used to control the active parts of the system to achieve the desired driver feedback torque.

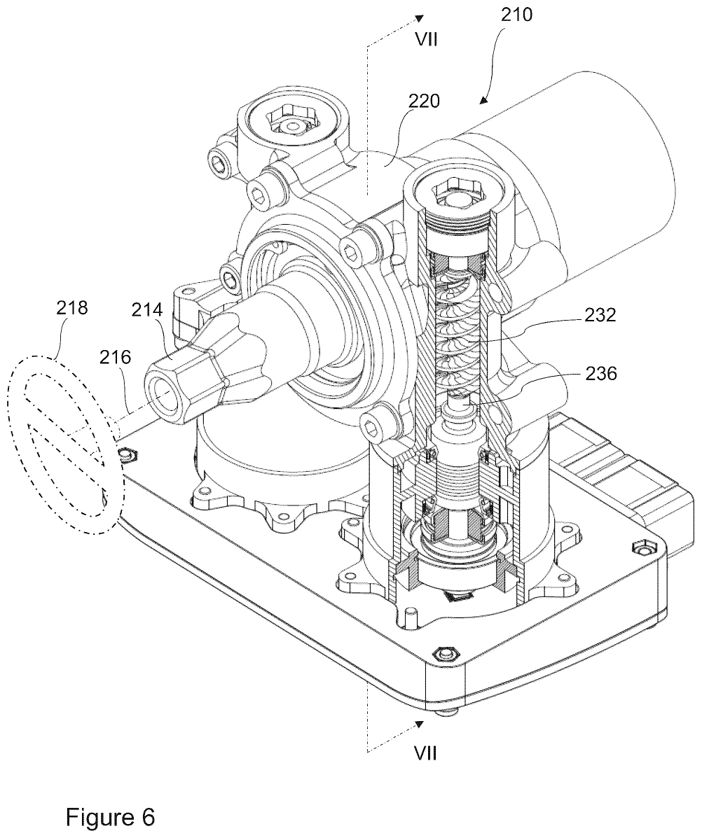

A second embodiment of the invention is illustrated in FIGS. 6 to 8. Many of the features of the second embodiment of very similar to those of the first embodiment, and corresponding features are identified with the same reference numerals, increased by 200.

The assembly 210 comprises a straight elongate steer-by-wire steering column 214 (only the lower end of which is illustrated) which is rotatably mounted about its longitudinal axis 216. A steering wheel 218 illustrated schematically in FIG. 1 is secured to the upper end of the steering column 214, by means of which the steering column 214 can be rotated by a driver. In the drawings, the steering column 214 is shown as a single shaft, but in practice it is likely to be formed from a number of components. For example, the steering column may be formed from several telescopic parts and may have a torque sensor (e.g. a torsion bar assembly) between the steering wheel 18 and the opposite end of the steering column 214.

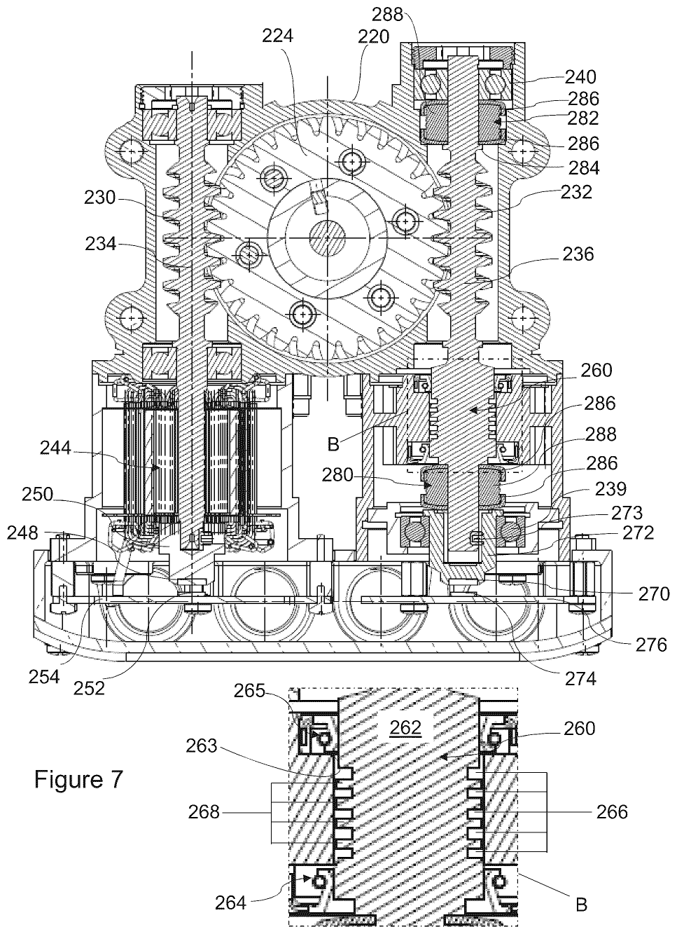

The opposite, lower end of the steering column 214 is received in a housing 220, in which it is rotatably mounted. As best seen in FIG. 7, a spur gear (pinion gear) 224 is fixedly mounted on the lower end of the steering column 214 within the housing 220, and is thereby constrained to rotate with the steering column 214 and steering wheel 218.

Two identical worm screws 230, 232 are mounted within the housing 220 and are meshed with the spur gear (pinion gear) 224 at diametrically opposed positions on opposite sides of the gear. Each of the worm screws 230, 232 is formed on the surface of a respective shaft 234, 236, the two shafts being oriented parallel to each other and perpendicularly with respect to the rotational axis 216 of the steering column 214. The shaft 234 is rotatably mounted within the housing by means of lower and upper bearings 238, 240 located in use just beyond the lower and upper ends of the worm screw 230. The shaft 236 is rotatably mounted within the housing by means of a lower bearing 239 located at the lower end of the shaft 236 and an upper bearing 240 located in use just beyond the upper end of the worm screw 230.

As best seen in FIG. 7, the first shaft 230 forms the output shaft of an electric motor 244 and is driven directly by the motor. A motion position sensor (MPS) target magnet 248 is fixedly secured to the lower end of a mounting cup 250 secured to the lower end of the shaft 234 below the motor 244 and thereby rotates with the shaft 234. The rotation of the MPS target magnet 240 is detected by a MPS sensor 252 mounted on the upper surface of an MPS sensor circuit board 254 mounted within the housing 220. An electronic control unit (ECU) (not shown in the drawings) is also mounted on the circuit board 254. The MPS target magnet 248 and the MPS sensor 252 are known, and different types of magnets and sensors may be used depending on the circumstances.

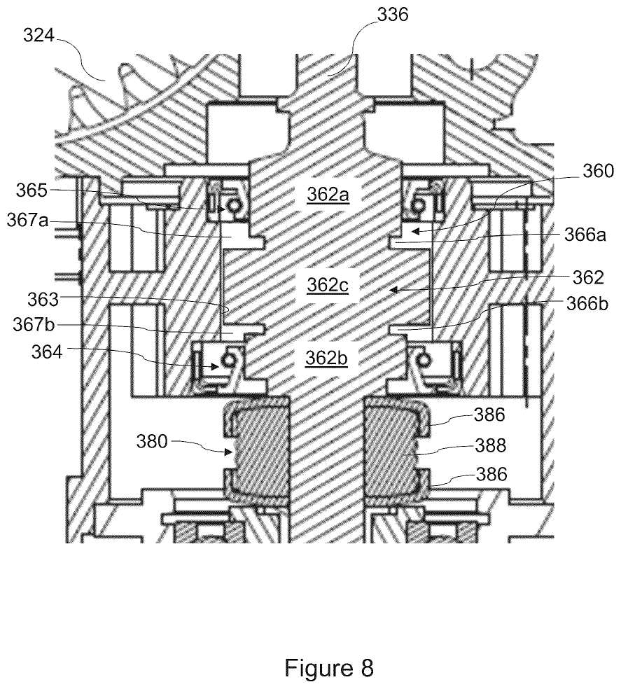

With further reference to FIGS. 7 and 8, a viscous damper indicated generally at 260 is mounted on the other shaft 232 at a location below the worm screw 232. The viscous damper comprises a generally cylindrical block 262 rotatably mounted within a complementarily-shaped cylindrical recess 263 within the housing 220. The recess 263 contains a damping fluid (e.g. silicone fluid) which is retained by annular lower and upper annular seals 264, 265 in contact with the lower and upper portions respectively of the cylindrical block 262. The central portion of the cylindrical block 262 is provided with five identical, equally spaced annular grooves 266 which define four identical annular fins 268 whose peripheries lie adjacent to, but slightly spaced from, the wall of the recess 263.

A motion position sensor (MPS) target magnet 270 is fixedly secured to the lower end of a mounting cup 272. The lower end of the damper shaft 232 is slidably mounted within the mounting cup 272 to allow it to be displaced along its rotational axis, but is rotationally located with respect to the mounting cup 272 by means of a key 273. The damper shaft 236 thereby rotates with the mounting cup 272 but is movable axially with respect to it. The rotation of the MPS target magnet 270 is detected by a MPS sensor 274 mounted on the upper surface of an MPS sensor circuit board 276. The MPS target magnet 270 and the MPS sensor 274 are known, and different types of magnets and sensors may be used depending on the circumstances.

As for the first embodiment, the viscous damper 260 resists rotation of the steering wheel and applies a feedback torque to the driver which is a function of the speed of rotation of the steering wheel. In addition, however, in this embodiment of the damper shaft 232 is also a movable longitudinally, coaxially with its rotational axis, so that the damper 260 provides damping in both the rotational and axial directions.

The upper end of the damper shaft 236 is slidably mounted in the upper bearing 240. As mentioned previously, the lower end of the damper shaft 236 is slidably mounted in, but rotationally fixed with respect to, the mounting cup 272. Therefore, the damper shaft 236 is also displaceable along its rotational axis, but by mounting the lower end of the damper shaft 236 within the mounting cup 272, a constant spacing is maintained between the MPS target magnet 270 and the MPS sensor 274 irrespective of the axial position of the damper shaft 236.

It will also be observed that a lower and upper annular compliant supports 280, 282 are mounted on the damper shaft 236. The lower compliant support 280 is mounted between the lower end of the cylindrical block 262 of the viscous damper 260 and the upper end of the mounting cup 272 and the upper compliant support 282 is mounted between a radially extending annular shoulder 284 located immediately above the upper end of the damper worm 232 and the inner face of the upper bearing 240. The lower and upper compliant supports 280, 282 are identical and are known, and each comprises identical upper and lower cup-shaped washers 286 arranged with their concave faces opposed to each other and a resiliently deformable (e.g. silicone rubber) annular plug 288 arranged between, and separating, the concave faces of the two washers 286.

The rotational torque applied by the viscous damper 260 is a function of the spacing between the periphery of the cylindrical block 262 and the wall of the recess 264, the number and dimensions of the grooves 266 and annular fins 268 and the viscosity of the damping fluid, as for the first embodiment.

In addition, in this embodiment the damper shaft 236 is also displaceable longitudinally, along its rotational axis which provides damping in longitudinal direction and helps to reduce acoustic noise that can occur as a result of impacts between the spur gear 224 and the worm 232 when the direction of motion of the spur gear changes. The lower and upper compliant supports 280, 282 provide a soft impact for the damper shaft 236 at the extreme ends of its longitudinal displacement.

A third embodiment of the present invention, which is a modification of the second embodiment, is illustrated in FIG. 8. The third embodiment is very similar to the second embodiment, and corresponding features are identified with the same reference numerals, increased by 100. The modification is to the damper body 262 of the second embodiment, and only that portion 362 of the third embodiment is therefore illustrated.

As shown in FIG. 8, a viscous damper 360 comprises a generally cylindrical block 362 rotatably mounted within a complementarily-shaped cylindrical recess 364 within a housing 320. The recess 363 contains a damping fluid (e.g. silicone fluid) which is retained by annular lower and upper annular seals 364, 365 in contact with the lower and upper portions 362a, 362b respectively of the cylindrical block 362. The central portion 362c of the cylindrical block 362 is also cylindrical, but of a larger diameter, spaced from the lower and upper portions 362a, 362b by peripheral grooves 366a, 366b. The diameter of the central portion 362c is slightly smaller than the internal diameter of the recess 363 and the central portion 362c is therefore spaced slightly from the inner wall of the recess 363.

As for the second embodiment, the damper 360 is displaceable both rotationally and longitudinally, along its rotational axis. The enlarged central portion 362c of the cylindrical block 362 produces a piston action within the recess 364 when the worm shaft 336 moves axially, i.e. by virtue of the transfer of fluid between the fluid cavities 367a, 367b on either side of the central portion 362c.

The construction and operation of the third embodiment is otherwise identical to that of the second embodiment.

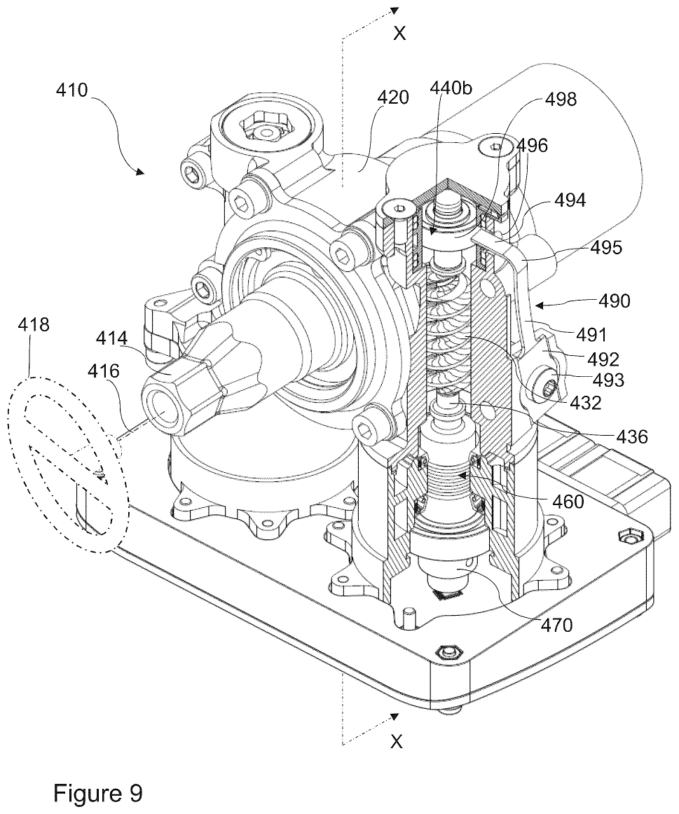

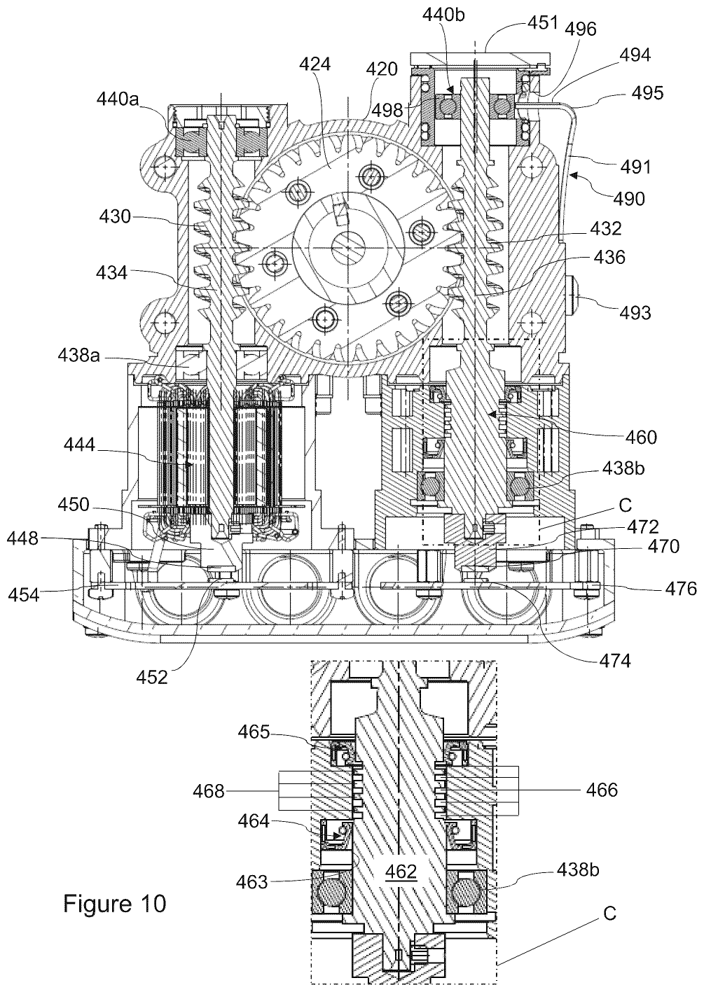

A fourth embodiment of the present invention is illustrated in FIGS. 9 and 10. Many of the features of the fourth embodiment of very similar to those of the first embodiment, and corresponding features are identified with the same reference numerals, increased by 400.

The assembly 410 comprises a straight elongate steer-by-wire steering column 414 (only the lower end of which is illustrated) which is rotatably mounted about its longitudinal axis 416. A steering wheel 418 illustrated schematically in FIG. 1 is secured to the upper end of the steering column 414, by means of which the steering column 414 can be rotated by a driver. In the drawings, the steering column 414 is shown as a single shaft, but in practice it is likely to be formed from a number of components. For example, the steering column may be formed from several telescopic parts and may have a torque sensor (e.g. a torsion bar assembly) between the steering wheel 418 and the opposite end of the steering column 414.

The opposite, lower end of the steering column 414 is received in a housing 420, in which it is rotatably mounted. As best seen in FIG. 3, a spur gear (pinion gear) 424 is fixedly mounted on the lower end of the steering column 414 within the housing 420, and is thereby constrained to rotate with the steering column 414 and steering wheel 418.

As best seen in FIG. 10, two identical worm screws 430, 432 are mounted within the housing 420 and are meshed with the spur gear (pinion gear) 424 at diametrically opposed positions on opposite sides of the gear. Each of the worm screws 430, 432 is formed on the surface of a respective shaft 434, 436, the two shafts being oriented parallel to each other and perpendicularly with respect to the rotational axis 416 of the steering column 414. The shafts 434, 436 are rotatably mounted within the housing by means of lower and upper bearings 438a, 440a; 438b, 440b. The lower and upper bearings 438b, 440b of the motor shaft 434 are located just beyond the lower and upper ends of the motor worm screw 430. The upper bearing 440b of the damper shaft 436 is located just beyond the upper end of the damper worm screw 432 and the lower bearing 438b is located towards the lower end of the damper shaft 436, in contrast to the position of the lower bearing of the first embodiment. In this embodiment, a cover plate 451 is also secured to the housing 420 over the upper end of the damper shaft 436.

As shown in FIGS. 9 and 10, a leaf spring 490 is mounted on the exterior of the housing 420. The leaf spring comprises a longer, generally straight portion 491 (although bent in use, as will be explained) having an enlarged head 492 at one end by means of which it is secured to the outer surface of the housing 420 by means of a bolt 493. A second, shorter generally straight portion 494 extends substantially perpendicularly to the longer portion 491 and the two portions are joined at a curved junction 495. The shorter portion 494 of the leaf spring 490 passes through an aperture 496 in the housing 420 and its free end abuts the outer race 498 of the upper bearing 440b of the damper shaft 436.

In use, the leaf spring 490 is mounted on the housing 420 so that the longer portion 491 is bent whereby a radial force is applied by the free end of the shorter portion 494 to the outer race 498 of the upper bearing 440b of the damper shaft 463, to retain the worm screw 432 in contact with the teeth of the spur gear 424.

As best seen in FIG. 10, the first shaft 430 forms the output shaft of an electric motor 444 and which is driven directly by the motor. A motion position sensor (MPS) target magnet 448 is fixedly secured to the lower end of a mounting cup 450 secured to the lower end of the shaft 434 below the motor 444 and thereby rotates with the shaft 434. The rotation of the MPS target magnet 440 is detected by a MPS sensor 452 mounted on the upper surface of an MPS sensor circuit board 454 mounted within the housing 420. An electronic control unit (ECU) (not shown in the drawings) is also mounted on the circuit board 454. The MPS target magnet 448 and the MPS sensor 452 are known, and different types of magnets and sensors may be used depending on the circumstances.

With further reference to FIG. 10, a viscous damper indicated generally at 460 is mounted on the other shaft 432 at a location between the lower bearing 438b and the lowermost end of the damper screw 432. The viscous damper 460 comprises a generally cylindrical block 462 rotatably mounted within a complementarily-shaped cylindrical recess 463 within the housing 420. The cylindrical block 462 of this embodiment is considerably longer than the corresponding cylindrical block 62 of the first embodiment, and its lower end extends to, and is mounted in, the lower bearing 438b. The central portion of the cylindrical block 462 is provided with five identical, equally spaced annular grooves 466 which define four identical annular fins 468 whose peripheries lie adjacent to, but slightly spaced from, the wall of the recess 463. The recess 463 contains a damping fluid (e.g. silicone fluid) which is retained by annular lower and upper annular seals 464, 465 in contact with the portions of the cylindrical block 462 immediately below and above the annular fins 468. The seals are selected to accommodate the movement of the shaft 432 as it articulates to maintain contact with the spur gear 424.

The torque applied by the viscous damper is a function of the spacing between the periphery of the cylindrical block 462 and the wall of the recess 463, the number and dimensions of the grooves 466 and annular fins 468 and the viscosity of the damping fluid, as for the previous embodiments. In this embodiment the damper is designed to be relatively insensitive to changes in the spacing between the block 462 and the walls 463 that may occur as the shaft 432 articulates.

A motion position sensor (MPS) target magnet 470 is fixedly secured to the lower end of a mounting cup 472 secured to the lower end of the damper shaft 436 below the viscous damper 460 and thereby rotates with the shaft 436. The rotation of the MPS target magnet 470 is detected by a MPS sensor 474 mounted on the upper surface of an MPS sensor circuit board 476. The MPS target magnet 470 and the MPS sensor 474 are known, and different types of magnets and sensors may be used depending on the circumstances.

The motor 444 provides a feedback torque to the steering column 416 (and thereby to the steering wheel 418) as a function of the driver demand. The viscous damper 460 also resists rotation of the steering wheel and applies a feedback torque to the driver which is a function of the speed of rotation of the steering wheel. The viscous damper 460 also helps to retain the worm 430 connected to the output of the motor 444 in contact with the spur gear 424 and helps to reduce gear rattle which can occur when the torque and direction of the motor are reversed. In addition, the viscous damper 460 also ensures that some degree of feedback torque is always generated, even if the motor 444 is inoperative.

Although the use of a spring 490 to bias the damper worm shaft is shown with respect to a particular embodiment, it is equally applicable to all the previous embodiments.

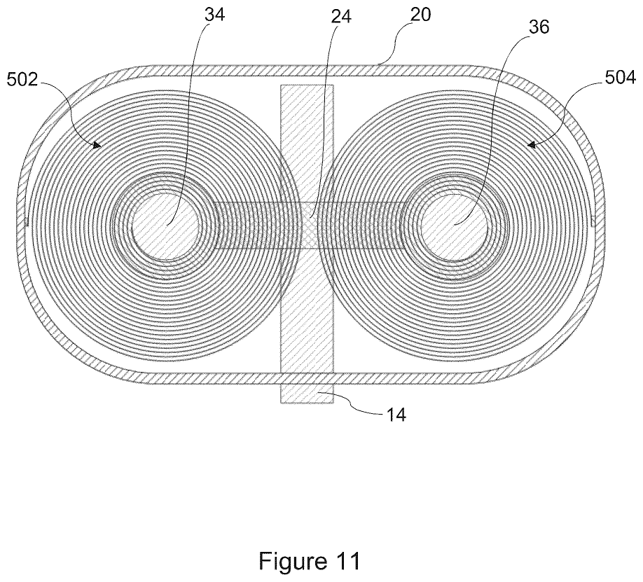

FIG. 11 is a transverse cross-section through a fifth embodiment of the present invention, which is a modification which can be used with any of the previous embodiments. The modification will be described with reference to the first embodiment, but it is equally applicable to all embodiments.

The FIG. 11 modification comprises the addition of a return spring that acts on the motor shaft 34, on the damper worm shaft 36 or on both the motor shaft 34 and the damper worm shaft 36. FIG. 11 shows the input shaft 14 which meshes with the spur gear (pinion gear) 24. The spur gear 24 is in turn meshed with the motor worm 30 on the motor worm shaft 34 and with the damper worm 32 on the damper shaft 36.

In this embodiment, a spiral spring 502 of the clock spring type is mounted at the upper end of the motor shaft 34 with the inner end of the spring 502 attached to the motor worm shaft 34 and the outer end of the spring 502 attached to the housing 20. Similarly, a second identical spiral spring 504 is mounted at the upper end of the damper shaft 36 with the inner end of the spring 502 attached to the damper shaft 36 and the outer end of the spring 504 attached to the housing 20. The spiral springs allow for a large angle of rotation within a small package.

In this particular embodiment, the two springs 502, 504 are arranged to act in partial opposition. The springs 502, 504 may be preloaded in opposite directions to keep them tensioned in the same direction over their full operating range. The preloading provides compensation for the backlash between the respective worms 30, 32 and the spur gear (pinion) 24. As a consequence, one or more of the arrangements for backlash control in the previous embodiments may be omitted, if desired.

In an alternative configuration, only a single spring 504 is used, in conjunction with the motor worm shaft 34. In that case, the return spring is arranged to provide a return torque over the full angular range of the handwheel 18. The net torque provided by the spring acts in a direction to return the handwheel to the straight-ahead angle. In addition, the torque provided by the spring increases as the handwheel is rotated further away from the straight-ahead angle.

In all of the above embodiments, the damper provides rotational damping to augment the motor feedback torque. In addition, in the event of a motor fault, the damper provides a passive feedback torque to the driver.

Coupling the damper via a second worm shaft provides a compact package which facilitates fitting into vehicles.

For those embodiments where axial movement and damping of the worm shaft is possible, acoustic noise from backlash in the worm and wheel gearbox is reduced, particularly when the handwheel direction is reversed.

Coupling the damper via a second worm shaft and controlling the backlash in the worm and wheel gearbox with a sprung worm system, as indicated above for the fifth embodiment, allows a damper to be included in a compact package with control of gearbox acoustic noise.

Providing a return spring on both the motor shaft and the damper shaft with a preload compensates for the worm/wheel compensation, which may be sufficient to remove the need for additional mechanisms.

The invention is not restricted to the details of the foregoing embodiments.

1. A steering column assembly for a vehicle, comprising:
an elongate steering column mounted for rotation about its longitudinal axis and configured for attachment of a steering wheel at one end;
a gear connected to the steering column at a location spaced from the steering wheel attachment location and configured to rotate with the steering column;
a motor comprising a rotatable output shaft;
a first worm screw directly connected to and rotatable with the output shaft of the motor and engaged with the gear;
a damper comprising a rotatable shaft;
a second worm screw directly connected to and rotatable with the shaft of the damper and engaged with the gear; and
control means configured to operate the motor.

2. A steering column assembly as claimed in claim 1, wherein the damper comprises a fluid chamber configured to receive a damping fluid and a body located within the fluid chamber, the body being configured to move with the rotatable shaft of the damper.

3. A steering column assembly as claimed in claim 2, wherein the body located within the fluid chamber comprises a plurality of projections and/or recesses.

4. A steering column assembly as claimed in claim 2, wherein the body located within the fluid chamber is spaced from the wall of the fluid chamber.

5. A steering column assembly as claimed in claim 2, wherein the body located within the fluid chamber comprises a portion of increased width.

6. A steering column assembly as claimed in claim 2, wherein the body located within the fluid chamber forms part of the rotatable shaft of the damper.

7. A steering column assembly as claimed in claim 2, wherein the body located within the fluid chamber is attached to the rotatable shaft of the damper.

8. A steering column assembly as claimed in claim 1, wherein the rotatable shaft of the damper is displaceable longitudinally in the direction of its rotational axis.

9. A steering column assembly as claimed in claim 8, wherein the rotatable shaft of the damper is mounted to allow it to pivot or articulate.

10. The steering column assembly as claimed in claim 9, comprising bearing means configured to allow pivoting or articulation of the rotatable damper shaft.

11. A steering column assembly as claimed in claim 1, comprising biasing means configured to urge the second worm screw towards contact with the gear connected to the steering column.

12. A steering column assembly as claimed in claim 9, comprising bearing means for rotatably mounting the rotatable shaft of the damper, with which the biasing means is engaged.

13. A steering column assembly as claimed in claim 10, wherein the biasing means is engaged with an outer race of the bearing means.

14. A steering column assembly as claimed in claim 11, wherein the biasing means comprises a spring.

15. A steering column assembly as claimed in claim 14, wherein the spring comprises a leaf spring.

16. A steering column assembly as claimed in claim 1, comprising a spring acting on the rotatable output shaft of the motor configured to apply a torque to the motor shaft and/or comprising a spring acting on the rotatable shaft of the damper configured to apply a torque to the damper shaft.

17. A steering column assembly as claimed in claim 16, wherein the spring acting on the rotatable output shaft of the motor and/or the spring acting on the rotatable shaft of the damper comprises a spiral spring.

18. A steering column assembly as claimed in claim 1, comprising motor position sensor means for sensing the rotational position of the motor output shaft, the sensor means comprising a target member rotatable with the motor shaft and a sensor for detecting the target member.

19. A steering column assembly as claimed in claim 1, comprising position sensor means for sensing the rotational position of the damper shaft, the sensor means comprising a target member rotatable with the damper shaft and a sensor for detecting the target member.

20. A steering column assembly as claimed in claim 19, comprising a member configured to rotate with the rotatable damper shaft and with respect to which the damper shaft is displaceable along its rotational axis, and on which the target member is mounted.

21. A steering column assembly as claimed in claim 20, comprising a cup-shaped member mounted at one end of the rotatable damper shaft and on which the motor position sensor means is mounted.

22. A steering column assembly as claimed in claim 1, wherein the first worm screw forms part of the motor output shaft and/or wherein the second worm screw forms part of the rotatable damper shaft.

23. A steering column assembly as claimed in claim 1, wherein the first and second worm screws are engaged at diametrically opposed locations with the gear connected to the steering column.

24. The steering column assembly as claimed in claim 1, comprising a housing within which the first and second worm screws and the gear connecting to the steering column are located.

25. A vehicle comprising a steering column assembly as claimed in claim 1.
